(19) United States
(12) Patent Application Publication
(10) Pub. No.: US 2015/0002782 A1
(43) Pub. Date: Jan. 1, 2015

(54) BACKLIGHT UNIT AND DISPLAY APPARATUS HAVING THE SAME

(71) Applicant: Samsung Display Co., Ltd., Yongin-City (KR)

(72) Inventors: Heugon KIM, Yongin-si (KR); JooYoung KIM, Suwon-si (KR); Hyoung-Joo KIM, Anyang-si (KR); Hayoung LEE, Seoul (KR); Joo Woan CHO, Seongnam-si (KR)

(73) Assignee: Samsung Display Co., Ltd., Yongin-City (KR)

(21) Appl. No.: 14/074,950

(22) Filed: Nov. 8, 2013

(30) Foreign Application Priority Data
Jun. 26, 2013 (KR) 10-2013-0073782

(51) Int. Cl. G02F 1/1335; F21V 8/00

(52) U.S. Cl. CPC G02F 1/1336; G02B 6/0031; G02B 6/0033
USPC 349/62; 362/611; 362/609; 362/606; 362/613

(57) ABSTRACT

A backlight unit includes a light source which emits light, a light guide plate which receives the light through an incident surface thereof and guides the light, and a back cover which accommodates the light source and is coupled to the light guide plate such which the incident surface is disposed in an inner space thereof, where an air guide area is defined between the light source and the light guide plate in the inner space, and the back cover includes an inclined surface inclined to the incident surface of the light guide plate in the air guide area.

This application claims priority to Korean Patent Application No. 10-2013-0073782, filed on Jun. 26, 2013, and all the benefits accruing therefrom under 35 U.S.C. §119, the content of which in its entirety is herein incorporated by reference.

### BACKGROUND

1. Field

The disclosure relates to a backlight unit and a display apparatus including the backlight unit. More particularly, the disclosure relates to an edge-illumination type backlight unit and a display apparatus including the backlight unit.

2. Description of the Related Art

In general, a flat display apparatus includes a display panel to display an image, a backlight unit to supply light to the display panel, and a bottom chassis to accommodate the backlight unit.

The backlight unit is classified into an edge-illumination type backlight unit and a direct-illumination type backlight unit. The edge-illumination type backlight unit has a relatively thin thickness, and thus the edge-illumination type backlight unit is widely used in a mobile display device.

### SUMMARY

Exemplary embodiments of the invention provide a backlight unit with enhanced light incident efficiency and reduced thickness.

Exemplary embodiments of the invention provide a display apparatus including the backlight unit.

According to an exemplary embodiment of the invention, a backlight unit includes a light source which emits light, a light guide plate which receives the light through an incident surface thereof and guides the light, and a back cover which accommodates the light source and is coupled to the light guide plate such that the incident surface is disposed in an inner space thereof, where an air guide area is defined between the light source and the light guide plate in the inner space, and the back cover includes an inclined surface inclined to the incident surface of the light guide plate in the air guide area.

According to another exemplary embodiment of the invention, a display apparatus includes a backlight unit including a light source part which emits light, a light guide plate which receives the light through an incident surface thereof and guides the light, and a back cover which accommodates the light source part and is coupled to the light guide plate such which the incident surface is disposed in an inner space thereof, and a display panel which receives the light guided by the light guide plate to display an image, where an air guide area is defined between the light source part and the light guide plate in the inner space, and the back cover includes an inclined surface inclined to the incident surface of the light guide plate in the air guide area.

According to exemplary embodiments, the air guide area is defined between the light source and the light guide plate and an inclined surface is in the back cover to correspond to the air guide area.

In such embodiments, the light emitted from the light source is reflected by the inclined surface in the air guide area to be guided to the incident surface, and thus a light incident efficiency of the light incident to the light guide plate is substantially improved.

### BRIEF DESCRIPTION OF THE DRAWINGS

The above and other features of the invention will become more apparent by describing in further detail exemplary embodiments thereof with reference to the accompanying drawings, in which:

FIG. 1 is an exploded perspective view of an exemplary embodiment of a display apparatus according to the invention;

FIGS. 2 and 3 are cross-sectional views showing a coupling structure between a back cover, a light source and a light guide plate shown in FIG. 1;

FIG. 4 is a cross-sectional view showing a coupling structure between a back cover, a light source and a light guide plate in an alternative exemplary embodiment of a display apparatus according to the invention;

FIG. 5 is a cross-sectional view showing a coupling structure between a back cover, a light source and a light guide plate in another alternative exemplary embodiment of a display apparatus according to the invention;

FIG. 6 is a plan view of an exemplary embodiment of a display apparatus according to the invention showing a position relation between a light source and a light guide plate thereof;

FIG. 7 is a plan view of an exemplary embodiment of a display apparatus according to the invention showing a stopper disposed on a back cover thereof;

FIG. 8 is a cross-sectional view taken along line II-IP shown in FIG. 7;

FIGS. 9A to 9C are views showing an exemplary embodiment of a method of accommodating the light source and the light guide plate in the back cover;

FIG. 10 is a cross-sectional view taken along line I-I′ shown in FIG. 1;

FIG. 11 is a cross-sectional view showing an alternative exemplary embodiment of a display apparatus according to the invention; and

FIG. 12 is a view showing a simulation result of light incident efficiency of an exemplary embodiment of the backlight unit.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings herein.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the invention will be described in detail with reference to the accompanying drawings.

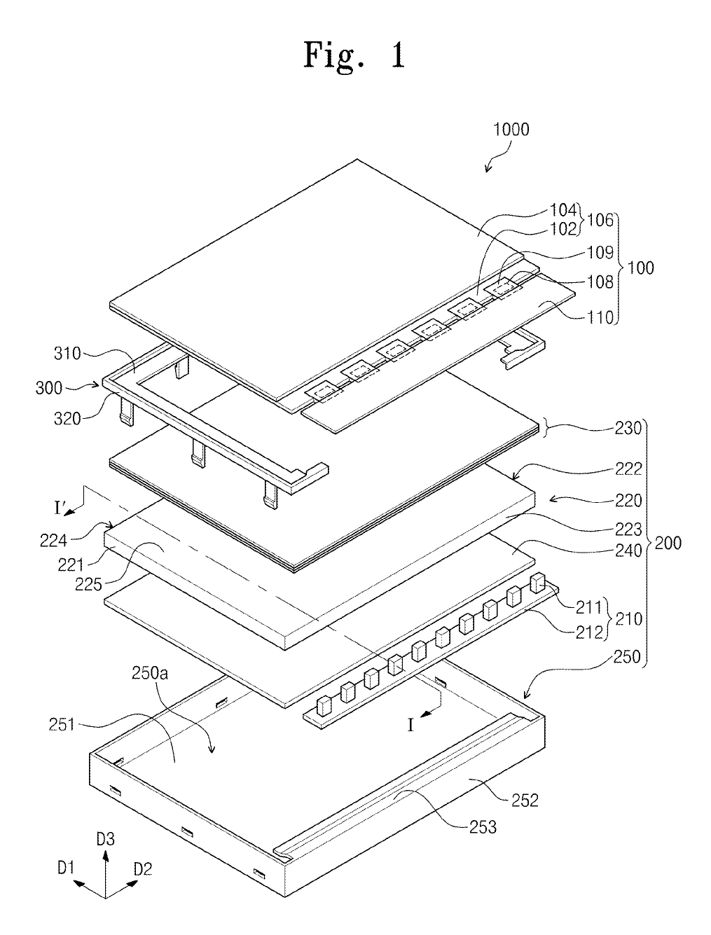

FIG. 1 is an exploded perspective view of an exemplary embodiment of a display apparatus according to the invention.

Referring to FIG. 1, an exemplary embodiment of a display apparatus 1000 includes a display unit 100, a backlight unit 200 and a mold frame 300.

The display apparatus 1000 has a substantially rectangular shape when viewed in a plan view. A short axis direction of the display apparatus 1000 is referred to as a first direction D1 and a long axis direction of the display apparatus 1000 is referred to as a second direction D2 substantially perpendicular to the first direction D1. In such an embodiment, the backlight unit 200, the mold frame 300 and the display unit 100 of the display apparatus 1000 are sequentially stacked one on another in a third direction D3 substantially vertical to the first and second directions D1 and D2. The third direction D3 may be a thickness direction of the display apparatus or components thereof, e.g., the backlight unit 200.

The display unit 100 includes a display panel 106 that displays an image, a driving chip 108 that applies a driving signal to the display panel 106, and a printed circuit board 110 electrically connected to the display panel 106.

In an exemplary embodiment, the display panel 106 includes a first substrate 102, a second substrate 104 disposed opposite to the first substrate 102 and coupled to the first substrate 104, and a liquid crystal layer (not shown) interposed between the first substrate 102 and the second substrate 104. In one exemplary embodiment, as shown in FIG. 1, the display panel 106 may be a liquid crystal display panel, but the display panel 106 is not be limited to the liquid crystal display panel.

The first substrate 102 includes a plurality of pixels arranged thereon substantially in a matrix form, and each of the pixels includes a gate line (not shown) extending substantially in the first direction D1, a data line (not shown) extending substantially in the second direction D2 and insulated from the gate line while crossing the gate line, and a pixel electrode (not shown). In such an embodiment, each of the pixels includes a thin film transistor (not shown) connected to the gate line, the data line and the pixel electrode.

The second substrate 104 includes color pixels (not shown), e.g., red, green and blue color pixels, and a common electrode facing the pixel electrode. The color pixels and the common electrode may be disposed on the first substrate 102. The liquid crystal layer includes liquid crystal molecules aligned based on an electric field generated between the pixel electrode and the common electrode to control a transmittance of light provided from the backlight unit 200, thereby displaying an image with gray-scale levels.

When viewed in a plan view, the driving chip 108 is disposed on a side portion of the first substrate 102 and applies a data signal to the data line. The driving chip 108 generates the data signal in response to an external signal and applies the data signal to the data line. The external signal is provided from the printed circuit board 110 and includes an image signal, various control signals or a driving voltage, for example.

The first substrate 102 includes a gate driving circuit disposed at different side portion from the side portion thereof to apply a gate signal to the gate line. In an exemplary embodiment, the gate driving circuit may be provided by a thin film process used to provide the display panel 106. In such an embodiment, the gate driving circuit may be built in the display panel 106.

In an alternative exemplary embodiment, the driving chip 108 may be configured to include two or more chips including a data driving chip and a gate driving chip and may be provided, e.g., mounted, on the first substrate 102 by a chip-on-glass process.

The printed circuit board 110 is electrically connected to the display panel 106 by a plurality of tape carrier packages (“TCP”s) 109. The driving chip 108 may be mounted on each of the TCPs 109. The TCPs 109 may be bent to wrap the side surface of the backlight unit 200.

In an exemplary embodiment, the printed circuit board 110 connected to the TCPs 109 is disposed under the backlight unit 200. In such an embodiment, the display apparatus 1000 may further include a shield case (not shown) disposed under the backlight unit 200 to protect the printed circuit board 110. Although not shown in the figure, the printed circuit board 110 may be disposed on a sidewall of the backlight unit 200.

The backlight unit 200 includes a light source part 210 that emits light, a light guide plate 220 that guides the light from the light source part 210 to the display unit 100, and a back cover 250 that accommodates the light source part 210 and the light guide plate 220.

In an exemplary embodiment, as shown in FIG. 1, the backlight unit 200 may be an edge-illumination type backlight unit. In such an embodiment, the light source part 210 is disposed under the display panel 106 and provides the light to a side surface of the light guide plate 220, and the light guide plate 220 guides the light incident thereto through the side surface thereof to the display unit 100.

The light guide plate 220 includes a first side surface 221 extending substantially in the first direction D1 of the display apparatus 1000, a second side surface 222 substantially parallel to the first side surface 221, a third side surface 223 extending substantially in the second direction D2 of the display apparatus 1000, and a fourth side surface 224 substantially parallel to the third side surface 223. In an exemplary embodiment, as shown in FIG. 1, the light source part 210 is disposed adjacent to the third side surface 223 of the light guide plate 220. In such an embodiment, the third side surface 223 will be referred to as an incident surface of the light guide plate 220.

The light source part 210 includes a plurality of light sources 211 sequentially arranged along the incident surface 223, and each of the light sources 211 may include a light emitting diode, for example, but not being limited thereto. The light source part 210 further includes a support film 212 on which the light sources 211 are disposed. The light sources 211 are arranged on the support film 212 along the second direction D2 and spaced apart from each other.

The backlight unit 200 further includes optical sheets 230 disposed between the light guide plate 220 and the display unit 100, and a reflection plate 240 disposed under the light guide plate 220.

The optical sheets 230 include a diffusion sheet that diffuses the light and a condensing sheet that condenses the light to improve brightness of the light emitted from an exit surface of the light guide plate 220 and visibility. In an exemplary embodiment, the optical sheets 230 may further include a protective sheet (not shown) disposed at an uppermost position in the optical sheets 230. The reflection plate 240 is disposed under the light guide plate 220 and reflects the light leaked from the light guide plate 220 such that the leaked light is incident to the light guide plate 220 again.

The back cover 250 includes a bottom portion 251 on which the light source part 210 and the light guide plate 220 are disposed, a sidewall 252 extending from the bottom portion 251 to the third direction D3, and a cover portion 253 extending from the sidewall 252 to cover the light source part 210 and which defines a space to which the incident surface 223 of the light guide plate 220 is disposed, e.g., inserted.

In one exemplary embodiment, for example, the back cover may include a material having light reflectivity such as a metal.

The mold frame 300 is disposed between the display unit 100 and backlight unit 200 and supports the display panel 106. The mold frame 300 includes a support portion 310 that supports the display panel 106 and a sidewall 320 extending from the support portion 310 to the third direction D3.

In an exemplary embodiment, the support portion 310 and the sidewall 320 of the mold frame 300, which are adjacent to the light source part 210, expose the cover portion 253 of the back cover 250. In such an embodiment, the display panel 106 is placed on the cover portion 253 in an area (hereinafter, referred to as light incident area) adjacent to the light source part 210.

In an exemplary embodiment, a double-sided tape (not shown) may be interposed between the display panel 106 and the cover portion 253. In such an embodiment, the display panel 106 is fixed to the cover portion 253 by the double-sided tape.

In an exemplary embodiment, a fixing tape (not shown) may be further disposed, e.g., attached, onto an edge of the display panel 106 to fix the display panel 106 to the mold frame 300.

In an exemplary embodiment, the display apparatus 1000 may further include a top cover (not shown) that covers the edge of the display panel 106 while being coupled to the back cover 250 without employing the fixing tape.

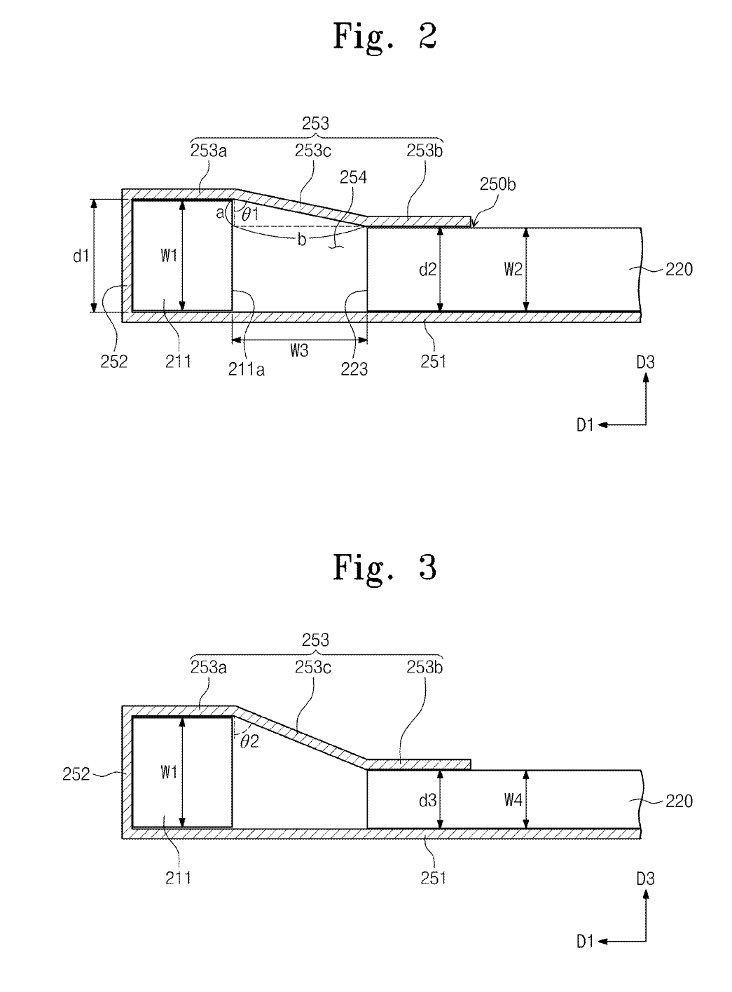

FIGS. 2 and 3 are cross-sectional views showing a coupling structure between the back cover, the light source and the light guide plate shown in FIG. 1. For the convenience of illustration, FIGS. 2 and 3 show only the light sources 211 and the light guide plate 220 of the backlight unit 200.

Referring to FIG. 2, the back cover 250 includes the bottom portion 251 on which the light sources 211 and the light guide plate 220 are disposed, the sidewall 252 extending from the bottom portion 251 to the third direction D3, and the cover portion 253 extending from the sidewall 252 to cover the light sources 211.

In an exemplary embodiment, the bottom portion 251 has a flat plate shape. In one exemplary embodiment, for example, the bottom portion 251 has a rectangular shape when viewed in a plan view. The sidewall 252 is substantially vertically extending from four sides of the bottom portion 251 to define a receiving space 250a (refer to FIG. 1). The cover portion 253 is disposed adjacent to one of the four sides of the bottom portion 251 and extending from the sidewall 252 to face the bottom portion 251.

The light source 211 and the support film 212 (refer to FIG. 1) are accommodated in an inner space of the back cover 250, which is defined by the bottom portion 251, the sidewall 252 and the cover portion 253, and the light guide plate 220 is inserted into a lead-in portion 250b of the inner space to be accommodated in the receiving space 250a.

The light source 211 includes a light emitting surface 211a from which the light exits, and the light emitting surface 211a is substantially parallel to the incident surface 223 of the light guide plate 220. The light source 211 is disposed to allow the light emitting surface 211a to face the incident surface 223 of the light guide plate 220.

In the inner space, the light emitting surface 211a of the light source 211 is spaced apart from the incident surface 223 of the light guide plate 220 by a predetermined distance. Thus, an air guide area 254 is defined between the light emitting surface 211a of the light source 211 and the incident surface 223 of the light guide plate 220 and guides the light from the light source 211 to the incident surface 223 of the light guide plate 220. The back cover 250 includes an inclined surface 253c inclined to the incident surface 223 of the light guide plate 220 in the air guide area 254.

In an exemplary embodiment, the cover portion 253 includes a first cover surface 253a substantially parallel to the bottom portion 251 and which covers the light source 211, and a second cover surface 253b substantially parallel to the bottom portion 251 and which covers an end portion of the light guide plate 220. The cover portion 253 further includes the inclined surface 253c disposed between the first cover surface 253a and the second cover surface 253b and inclined to the incident surface 223 in the air guide area 254. The inclined surface 253c reflects the light emitted from the light emitting surface 211 and guides the reflected light to be incident to the incident surface 223.

In an exemplary embodiment, the backlight unit 200 employs a light source having a substantially large light emitting surface. In such an embodiment, a width w1 in the third direction D3 of the light emitting surface 211a is greater than a width w2 in the third direction D3 of the incident surface 223. In such an embodiment, a first separation distance d1 between the first cover surface 253a and the bottom portion 251 is set to be greater than a second separation distance d2 between the second cover surface 253b and the bottom portion 251.

Due to a difference between the first separation distance d1 and the second separation distance d2, the inclined surface 253c is inclined at a first inclination angle θ1 with respect to the light emitting surface 211a. The first inclination angle θ1 is greater than about 0° and less than about 90°. However, the first inclination angle θ1 of the inclined surface 253c is determined based on the difference between the first and second separation distances d1 and d2 and a width w3 of the air guide area 254, i.e., a separation distance between the light emitting surface 211a and the incident surface 223.

In an exemplary embodiment, as shown in FIG. 3, when the width w2 in the third direction D3 of the incident surface 223 of the light guide plate 220 may be reduced to a width w4, i.e., when the thickness of the light guide plate 220 is reduced, a third separation distance d3 between the second cover surface 253b and the bottom portion 251 becomes less than the second separation distance d2 (refer to FIG. 2). In such an embodiment, the inclined surface 253c is inclined at a second inclination angle θ2 less than the first inclination angle θ1.

Referring back to FIG. 2, since a tangent of the first inclination angle θ1, that is, tan(θ1), is defined by ‘b/a’, where ‘a’ is a value of the difference between the first separation distance d1 and the second separation distance d2, and ‘b’ is a value of the width w3 of the air guide area 254, or the separation distance between the light emitting surface 211a and the incident surface 223, the value ‘b’ satisfies the following Equation.

b=a tan(θ1)=(d1−d2)tan(θ1) Equation

In such an embodiment, the width w3 in the first direction D1 of the air guide area 254 may be substantially equal to or greater than the value V.

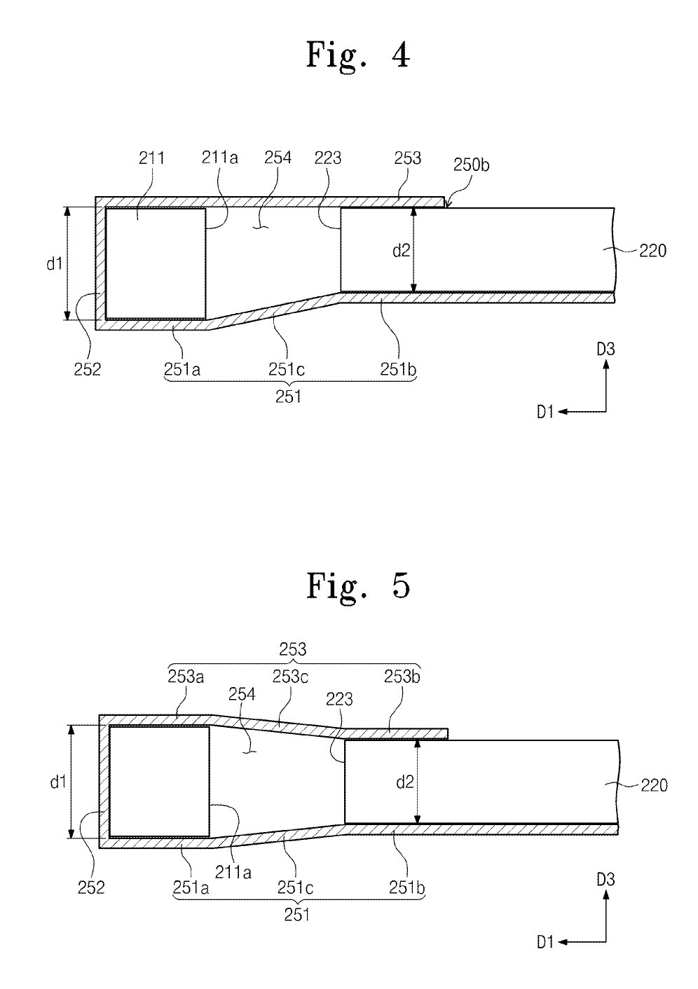

FIG. 4 is a cross-sectional view showing a coupling structure between a back cover, a light source and a light guide plate in an alternative exemplary embodiment of a display apparatus according to the invention.

Referring to FIG. 4, the back cover 250 includes the bottom portion 251 on which the light sources 211 and the light guide plate 220 are disposed, the sidewall 252 substantially vertically extending from the bottom portion 251, and the cover portion 253 extending from the sidewall 252 to cover the light sources 211.

In an exemplary embodiment, the cover portion 253 may have a flat plate shape. In such an embodiment, the bottom portion 251 includes a first bottom surface 251a on which the light source 211 is disposed, a second bottom surface 251b on which the light guide plate 220 is disposed, and an inclined surface 251c disposed between the first bottom surface 251a and the second bottom surface 251b. The first and second bottom surfaces 251a and 251b are substantially parallel to the cover portion 253.

The light source 211 and the support film 212 (refer to FIG. 1) are accommodated in the inner space defined by the bottom portion 251, the sidewall 252 and the cover portion 253, and the light guide plate 220 is inserted into the lead-in portion 250b of the inner space to be accommodated in the receiving space 250a.

In the inner space, an air guide area 254 is defined between the light emitting surface 211a of the light source 211 and the incident surface 223 of the light guide plate 220 to guide the light. The inclined surface 251c of the bottom portion 251 is inclined to the incident surface 223 of the light guide plate 220 in the air guide area 254. Accordingly, the inclined surface 251c reflects the light emitted from the light emitting surface 211 and guides the reflected light to be incident to the incident surface 223.

In an exemplary embodiment, as shown in FIG. 4, a first separation distance d1 between the cover portion 253 and the first bottom surface 251a is greater than a second separation distance d2 between the cover portion 253 and the second bottom surface 251b. Therefore, the inclined surface 251c is inclined to the incident surface 223 of the light guide plate 220.

The light guide plate 220 may have a thickness substantially equal to the second separation distance d2. Accordingly, the end portion of the light guide plate 220 may be inserted into the space between the cover portion 253 and the second bottom surface 251b to fit the space between the cover portion 253 and the second bottom surface 251b, and thus the light guide plate 220 may be effectively maintained in the space between the cover portion 253 and the second bottom surface 251b or effectively prevented from moving after being accommodated in the back cover 250.

As described above, when the back cover 250 and the light guide plate 220 are coupled to each other, a light leakage phenomenon may be effectively prevented in an area around the light incident surface 223.

In such an embodiment, where the light emitting surface 221a of the light source 211 is greater than the light incident surface 223 of the light guide plate 220, the light guide plate 220 may have the flat plate shape. Thus, in such an embodiment, the light guide plate 220 may be efficiently manufactured by an extrusion molding method. When the light guide plate 220 is manufactured by the extrusion molding method, the thickness of the light guide plate 220 becomes thinner, e.g., about 0.3 millimeters.

FIG. 5 is a cross-sectional view showing a coupling structure between a back cover, a light source and a light guide plate in another alternative exemplary embodiment of a display apparatus according to the invention.

Referring to FIG. 5, the back cover 250 includes a bottom portion 251 on which the light sources 211 and the light guide plate 220 are disposed, a sidewall 252 vertically extending from the bottom portion 251, and a cover portion 253 extending from the sidewall 252 to cover the light sources 211.

The bottom portion 251 includes a first bottom surface 251a on which the light sources 211 are disposed, a second bottom surface 251a on which the light guide plate 220 is disposed, and a first inclined surface 251c disposed between the first bottom surface 251a and the second bottom surface 251b. The second bottom surface 251b is substantially parallel to the first bottom surface 251a. The cover portion 253 includes a first cover surface 253a substantially parallel to the first bottom surface 251a and which covers the light source 211, a second cover surface 253b substantially parallel to the second bottom surface 251b and which covers an end portion of the light guide plate 220, and a second inclined surface 253c disposed between the first cover surface 253a and the second cover surface 253b.

In the inner space, an air guide area 254 is defined between the light emitting surface 211a of the light sources 211 and the incident surface 223 of the light guide plate 220 to guide the light. The first and second inclined surfaces 251c and 253c are inclined to the light incident surface 223 of the light guide plate 220 in the air guide area 254. Thus, the first and second inclined surfaces 251c and 253c reflect the light emitted from the light emitting surface 211 and guide the reflected light to be incident to the incident surface 223.

In an exemplary embodiment, as shown in FIG. 5, a first separation distance d1 between the first cover surface 253a and the first bottom surface 251a is greater than a second separation distance d2 between the second cover surface 253b and the second bottom surface 251b. In such an embodiment, a separation distance between the first inclined surface 251c and the second inclined surface 253c gradually decreases as it is closer to the light guide plate 220. The first and second inclined surfaces 251c and 253c are inclined at the same inclination angle or different angles with respect to the light emitting surface 211a.

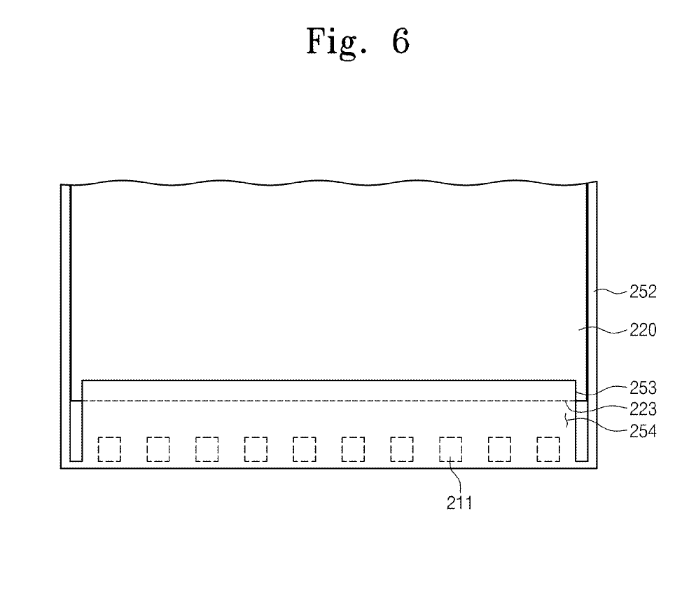

FIG. 6 is a plan view showing a position relation between the light source and the light guide plate in an exemplary embodiment of a display apparatus according to the invention.

Referring to FIG. 6, the light sources 211 and the end portion of the light guide plate 220 are covered by the cover portion 253 of the back cover 250. In FIG. 6, the light sources 211 and the end portion of the light guide plate 220, which are disposed in the inner space between the cover portion 253 and the bottom portion 251, are represented by a dotted line.

The light sources 211 are spaced apart from the light guide plate 220 by a predetermined distance in the inner space. Thus, the air guide area 254 is defined between the light guide plate 220 and the light sources 211.

The light sources 211 are arranged along a longitudinal direction of the incident surface 223 of the light guide plate 220 at a substantially constant interval. The light emitted from the light sources 211 is incident to the incident surface 223 of the light guide plate 220 after passing through the air guide area 254. In general, a difference in brightness between the area for the light sources 211 and the area between the light sources 211 becomes greater as a position, at which the brightness is measured, is closer to the light sources 211. In an exemplary embodiment, as shown in FIG. 6, the air guide area 254 is defined between the incident surface 223 and the light sources 211, such that the difference in brightness may be effectively prevented from being perceived as a hot spot.

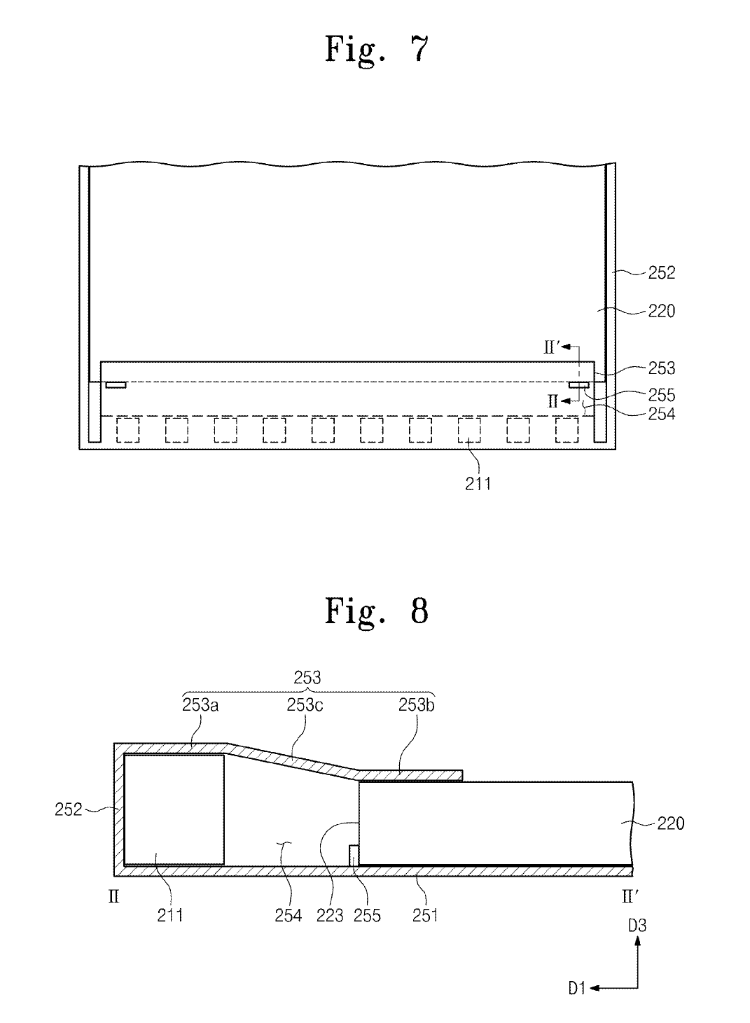

FIG. 7 is a plan view of an exemplary embodiment of a display apparatus according to the invention showing a stopper disposed on the back cover, and FIG. 8 is a cross-sectional view taken along line II-IP shown in FIG. 7.

Referring to FIGS. 7 and 8, the back cover 250 may further include a stopper 255 that effectively prevents the light guide plate 220 from moving into the air guide area 254.

The stopper 255 may be a protrusion formed by processing the bottom portion 251 of the back cover 250 and engaged with the incident surface 223 of the light guide plate 220, thereby effectively preventing the light guide plate 220 from moving into the air guide area 254.

In an alternative exemplary embodiment, the stopper 255 may be a separate structure attached to the bottom portion 251 of the back cover 250.

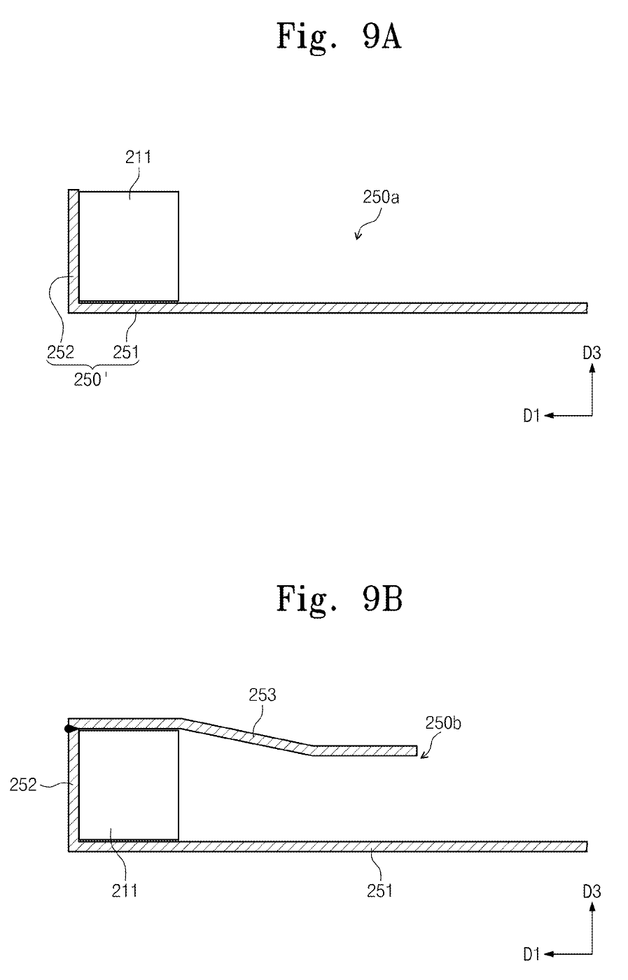

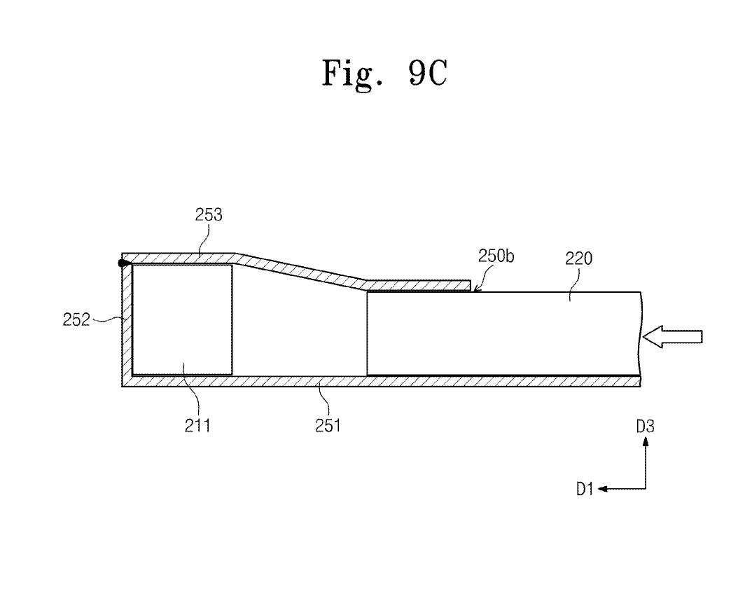

FIGS. 9A to 9C are views showing an exemplary embodiment a method of accommodating the light source and the light guide plate in the back cover.

Referring to FIG. 9A, an initial back cover 250′ including the bottom portion 251 and the sidewall 252 is provided. The receiving space 250a is defined in the initial back cover 250a by the bottom portion 251 and the sidewall 252, and the light source part 210 is accommodated in the receiving space 250a. FIG. 9A shows only the light sources 211 of the light source part 210 with the initial back cover 250′.

When the light source part 210 is accommodated in the receiving space 250a, the cover portion 253 is connected to an upper end of the sidewall 252 to complete the back cover 250 as shown in FIG. 9B. In an exemplary embodiment, the connection between the cover portion 253 and the sidewall 252 may be performed by a welding process.

The cover portion 253 covers the light source part 210 and faces the bottom portion 251 to form the lead-in portion 250b, into which an end portion of the light guide plate 220 is inserted.

As shown in FIG. 9C, the end portion of the light guide plate 220 is inserted into the inner space through the lead-in portion 250b.

One exemplary embodiment of the method of accommodating the light source part 210 and the light guide plate 220 in the back cover 250 is shown in FIGS. 9A to 9C, but the invention is not be limited thereto.

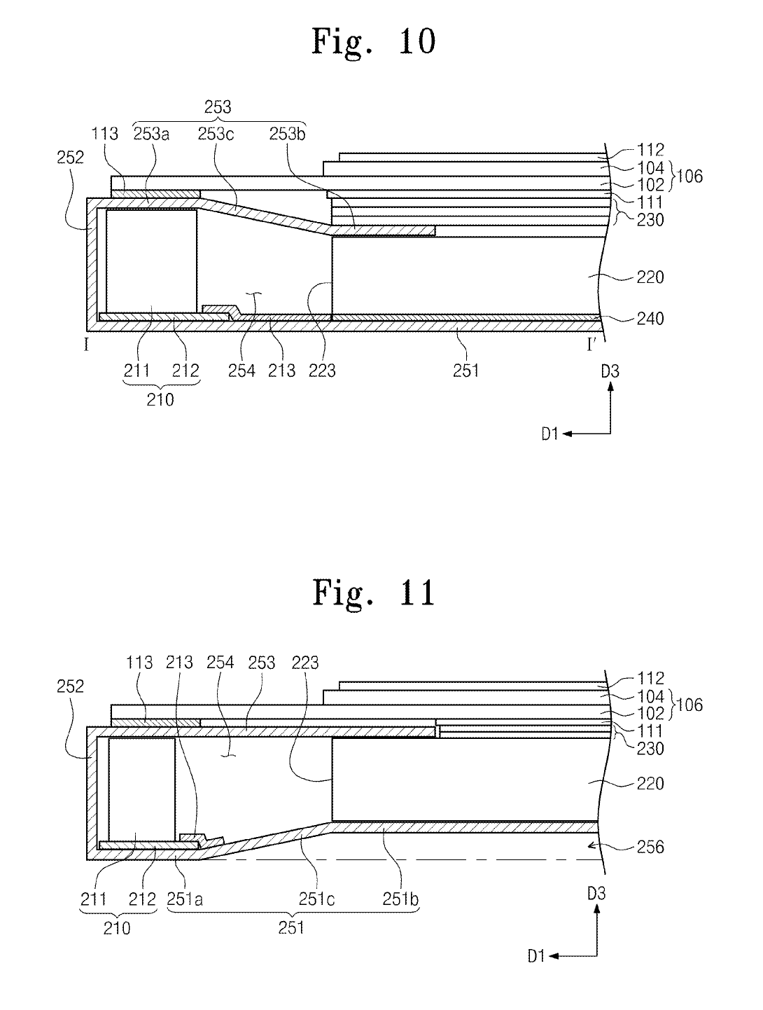

FIG. 10 is a cross-sectional view taken along line I-I′ shown in FIG. 1.

In an exemplary embodiment, the light source part 210 and the light guide plate 220 may be accommodated in the back cover 250 through a method shown in FIGS. 9A to 9C.

Referring to FIG. 10, the reflection plate 240 is disposed between the light guide plate 220 and the bottom portion 251 of the back cover 250.

In such an embodiment, a reflection tape 213 is disposed in the air guide area 254 to maintain a position of the support film 212 of the light source 210 on the bottom portion 251 of the back cover 250, e.g., to fix the support film 212 of the light source 210 to the bottom portion of the back cover 250. The reflection tape 213 may include a reflective material to fix the support film 212 to the bottom portion 251 and to reflect the light emitted from the light sources 211 to the incident surface 223 of the light guide plate 220.

In an exemplary embodiment, as shown in FIG. 10, the optical sheets 230 are disposed above the second cover surface 253b and the light guide plate 220. In one exemplary embodiment, for example, the optical sheets 230 may be directly mounted on the second cover surface 253b. In such an embodiment, due to the difference in height between the first cover surface 253 a and the second cover surface 253b, a receiving space, in which the optical sheets 230 are accommodated, may be defined on the backlight unit 220.

In such an embodiment, where the thickness of the light emitting portion of the backlight unit 200 is increased by the extension of the light emitting surface 211a of the light sources 211, the thickness of the backlight unit 200 may be effectively prevented from increasing by the extension of the light emitting surface 211a of the light sources 211, and thus the thickness of the display apparatus 1000 may be reduced while increasing the light emitting surface 211a of the light sources 211.

The display panel 106 is disposed on the optical sheets 230. A first polarizing plate 111 is disposed under, e.g., attached to, a lower surface of the first substrate 102 of the display panel 106 and a second polarizing plate 112 disposed on, e.g., is attached to, an upper surface of the second substrate 104 of the display panel 106.

In an exemplary embodiment, an end portion of the display panel 106 is disposed on and supported by the first cover surface 253a. A double-sided tape 113 may be disposed between the first cover surface 253a and the display panel 106 to fix the display panel 106 to the first cover surface 253a.

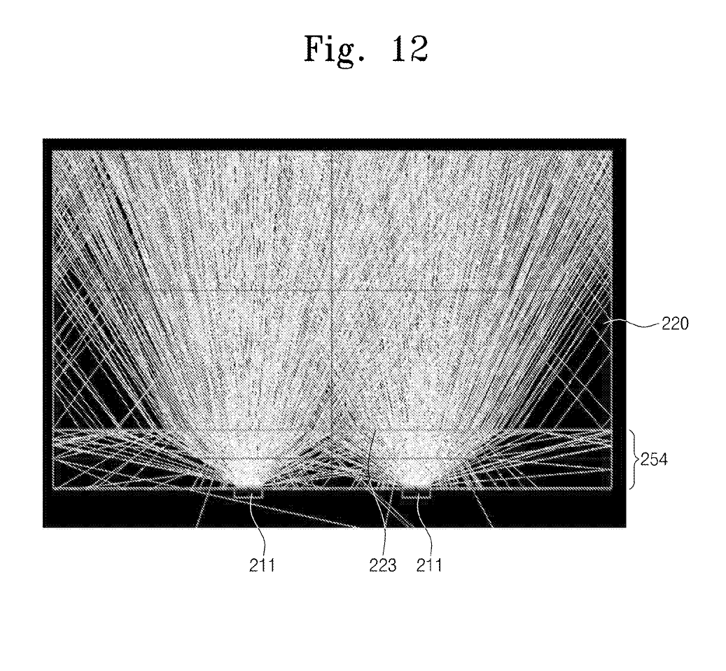

FIG. 11 is a cross-sectional view showing an alternative exemplary embodiment of a display apparatus according to the invention. The display apparatus in FIG. 11 is substantially the same as the display apparatus shown in FIG. 10 except for the back cover 250. The same or like elements shown in FIG. 11 have been labeled with the same reference characters as used above to describe the exemplary embodiments of the display apparatus shown in FIG. 10, and any repetitive detailed description thereof may be omitted or simplified.

Referring to FIG. 11, the back cover 250 includes the bottom portion 251 on which the light sources 211 and the light guide plate 220 are disposed, the sidewall 252 vertically extending from the bottom portion 251, and the cover portion 253 extending from the sidewall 252 to cover the light sources 211.

In an exemplary embodiment, as shown in FIG. 11, the cover portion 253 may have a flat plate shape. In such an embodiment, the bottom portion 251 includes a first bottom surface 251a on which the light sources 211 are disposed, a second bottom surface 251b on which the light guide plate 220 is disposed, and an inclined surface 251c disposed between the first bottom surface 251a and the second bottom surface 251b. The first and second bottom surfaces 251a and 251b are substantially parallel to each other to the cover portion 253.

The light sources 211 and the support film 212 are accommodated in the inner space defined by the bottom portion 251, the sidewall 252 and the cover portion 253, and the light guide plate 220 is inserted into the lead-in portion 250b of the inner space to be accommodated in the receiving space 250a as shown in FIG. 4.

In an exemplary embodiment, the back cover 250 may include a material with high reflectivity, such that the second bottom surface 251b may perform the function as the reflection plate 240 (refer to FIG. 10). In such an embodiment, the reflection plate 240 may be omitted from the area between the light guide plate 220 and the second bottom surface 251b, such that the thickness of the display apparatus 1000 is reduced by the thickness of the reflection plate 240 omitted from the area between the light guide plate 220 and the second bottom surface 251b.

In such an embodiment, the thickness of the optical sheets 230 becomes thin, and the optical sheets 230 may be disposed in a space defined by the cover portion 253 and the display panel 106 on the light guide plate 220. In such an embodiment, the inclined surface 251c of the back cover 250 may be in the bottom portion 251 to provide a rear receiving space 256 at the rear side of the bottom portion 251. Various elements of the display apparatus 1000 may be accommodated in the rear receiving space 256, and thus the display apparatus 1000 may have a substantially thin thickness.

FIG. 12 is a view showing a simulation result of light incident efficiency of an exemplary embodiment of the backlight unit shown in FIG. 10. FIG. 12 shows the light incident efficiency of the backlight unit from a simulation where two light sources are disposed adjacent to the incident surface of the light guide plate.

Referring to FIG. 12, the air guide area 254 is defined between the incident surface 223 of the light guide plate 220 and the two light sources 211 and an inclined surface 253c is in the back cover 250 to correspond to the air guide area 254. Therefore, the light emitted from the two light sources 211 is reflected by the inclined surface 253c in the air guide area 254 to be guided to the incident surface 223. Accordingly, the light incident efficiency of the light traveling to the light guide plate 220 may be improved.

In one exemplary embodiment, for example, the inclined surface 253c of the back cover 250 may include a layer including silver, e.g., by being coated with silver, to enhance the reflectivity of the incline surface 253c.

In an exemplary embodiment, the light sources 211 are spaced apart from the incident surface 223 of the light guide plate 220 by the air guide area 254, and the hot spot occurring in the light incident portion is thereby effectively prevented from being perceived on the screen of the display apparatus 1000. Thus, the display quality of the display apparatus 1000 is substantially improved.

Although the exemplary embodiments of the invention have been described, it is understood that the invention should not be limited to these exemplary embodiments but various changes and modifications can be made by one ordinary skilled in the art within the spirit and scope of the invention as hereinafter claimed.

What is claimed is:

1. A backlight unit comprising:
a light source part which emits light;
a light guide plate which receives the light through an incident surface thereof and guides the light; and
a back cover which accommodates the light source part and is coupled to the light guide plate such that the incident surface is disposed in an inner space thereof,
wherein
an air guide area is defined between the light source part and the light guide plate in the inner space of the back cover, and
the back cover comprises an inclined surface inclined to the incident surface of the light guide plate in the air guide area.

2. The backlight unit of claim 1, wherein
the light source part comprises a light emitting surface, from which the light exits,
the light emitting surface is substantially parallel to the incident surface of the light guide plate, and
the light emitting surface has a width in a thickness direction of the backlight unit greater than a width of the incident surface in the thickness direction of the backlight unit.

3. The backlight unit of claim 2, wherein the back cover comprises:
a bottom portion on which the light source part and the light guide plate are disposed; and
a cover portion which covers the light source part and an end portion of the light guide plate,
wherein the cover portion comprises:
a first cover surface substantially parallel to the bottom portion and which covers the light source part;
a second cover surface substantially parallel to the bottom portion and which covers the end portion of the light guide plate; and
the inclined surface disposed between the first cover surface and the second cover surface.

4. The backlight unit of claim 3, wherein
a separation distance between the first cover surface and the bottom portion is greater than a separation distance between the second cover surface and the bottom portion.

5. The backlight unit of claim 2, wherein the back cover comprises:
a bottom portion on which the light source part and the light guide plate are disposed; and
a cover portion which covers the light source part and an end portion of the light guide plate, and has a flat shape,
wherein the bottom portion comprises:
a first bottom surface on which the light source part is disposed, wherein the first bottom surface is substantially parallel to the cover portion;
a second bottom surface on which the light guide plate is disposed, wherein the second bottom surface is substantially parallel to the cover portion; and
the inclined surface disposed between the first bottom surface and the second bottom surface.

6. The backlight unit of claim 5, wherein
a separation distance between the first bottom surface and the cover portion is greater than a separation distance between the second bottom surface and the cover portion.

7. The backlight unit of claim 2, wherein the back cover comprises:
a bottom portion on which the light source part and the light guide plate are disposed; and
a cover portion which covers the light source part and an end portion of the light guide plate,
wherein the bottom portion comprises:
a first bottom surface on which the light source part is disposed;
a second bottom surface on which the light guide plate is disposed, wherein the second bottom surface is substantially parallel to the first bottom surface; and
a first inclined surface disposed between the first bottom surface and the second bottom surface, and
wherein the cover portion comprises:
a first cover surface substantially parallel to the first bottom surface and which covers the light source part;
a second cover surface substantially parallel to the second bottom surface and which covers the end portion of the light guide plate; and
a second inclined surface disposed between the first cover surface and the second cover surface.

8. The backlight unit of claim 7, wherein
a separation distance between the first cover surface and the first bottom surface is greater than a separation distance between the second cover surface and the second bottom surface.

9. The backlight unit of claim 8, wherein
a separation distance between the first inclined surface and the second inclined surface decreases as it is closer to the light guide plate.

10. The backlight unit of claim 1, wherein the back cover further comprises a material having light reflectivity.

11. The backlight unit of claim 1, wherein the back cover further comprises a stopper which blocks the light guide plate from entering into the air guide area.

12. The backlight unit of claim 11, wherein the stopper is protruded from the back cover and engaged with the incident surface of the light guide plate.

13. The backlight unit of claim 1, further comprising an optical sheet disposed above the light guide plate.

14. The backlight unit of claim 1, further comprising a reflection plate disposed between a lower surface of the light guide plate and the back cover.

15. The backlight unit of claim 1, wherein
the light source part comprises a plurality of light sources, and
the light sources are arranged along a longitudinal direction of the incident surface.

16. The backlight unit of claim 1, wherein the air guide area has a length greater than a length of the inclined surface.

17. The backlight unit of claim 1, wherein an inner angle between the inclined surface and a light emitting surface of the light source unit, from which the light exits, is in a range of about 0° to about 90°.

18. The backlight unit of claim 17, wherein the inner angle between the inclined surface and the light emitting surface is set to a predetermined angle such that the light emitted from the light emitting surface is prevented from being re-incident to the light emitting surface after the light is reflected by the inclined surface.

19. A display apparatus comprising:
a backlight unit comprising:
a light source part which emits light;
a light guide plate which receives the light through an incident surface thereof and guides the light; and
a back cover which accommodates the light source part and is coupled to the light guide plate such which the incident surface is disposed in an inner space thereof;
and
a display panel which receives the light guided by the light guide plate to display an image,
wherein
an air guide area is defined between the light source part and the light guide plate in the inner space, and
the back cover comprises an inclined surface inclined to the incident surface of the light guide plate in the air guide area.

20. The display apparatus of claim 19, wherein
the back cover comprises:
a bottom portion on which the light source part and the light guide plate are disposed; and
a cover portion which covers the light source part and an end portion of the light guide plate, and
the cover portion comprises:
a first cover surface substantially parallel to the bottom portion and which covers the light source;
a second cover surface substantially parallel to the bottom portion and which covers the end portion of the light guide plate; and
the inclined surface disposed between the first cover surface and the second cover surface.

21. The display apparatus of claim 20, wherein
the light source part comprises a light emitting surface, from which the light exits,
the light emitting surface is substantially parallel to the incident surface of the light guide plate,
the light emitting surface has a width in a thickness direction of the backlight unit greater than a width of the incident surface in the thickness direction of the backlight unit, and
a separation distance between the first cover surface and the bottom portion is greater than a separation distance between the second cover surface and the bottom portion.
